(19) United States
(12) Patent Application Publication
(10) Pub. No.: US 2009/0010478 A1
(43) Pub. Date: Jan. 8, 2009

(54) LOUDSPEAKER DEVICE AND DISPLAY ASSEMBLY HAVING THE SAME

(76) Inventors: Guan-De LIOU, Taipei City (TW); Chia-Pine HUANG, Keelung City (TW); Li-Li LAI, Taipei City (TW); Stephen TSAI, Taipei County (TW)

Correspondence Address: OSTROLENK FABER GERB & SOFFEN, 1180 AVENUE OF THE AMERICAS, NEW YORK, NY, 100368403, US

(21) Appl. No.: 11/955,473

(22) Filed: Dec. 13, 2007

(30) Foreign Application Priority Data
Jul. 3, 2007 (TW) 096124108

(51) Int. Cl. H04R 1/02

(52) U.S. Cl. 381/387; 381/388

(57) ABSTRACT

A loudspeaker device includes a flexible base member having a lower mounting plate portion, and an upper hanging portion connected to and disposed above the lower mounting plate portion, and a loudspeaker unit mounted on a first side surface of the lower mounting plate portion of the base member. The upper hanging portion of the base member is detachably hung on a display unit.

### CROSS-REFERENCE TO RELATED APPLICATION

This application claims priority of Taiwanese Application No. 096124108, filed on Jul. 3, 2007.

### BACKGROUND OF THE INVENTION

1. Field of the Invention

The invention relates to a loudspeaker device, more particularly to a hanging-type loudspeaker device, and a display assembly having the same.

2. Description of the Related Art

Referring to FIG. 1, a conventional display assembly is shown to include a flat display 11 having opposite lateral sides each formed with a sliding groove 111, and two loudspeaker units 12 each having an engaging rib 121 that engages slidably and detachably a corresponding one of the sliding grooves 111.

In such a configuration, since the loudspeaker units 12 cannot be stably positioned on other objects, such as articles of furniture and when removed from the flat display 11, they are easily damaged.

### SUMMARY OF THE INVENTION

The object of the present invention is to provide a hanging-type loudspeaker device and a display assembly having the same that can overcome the aforesaid drawback of the prior art.

According to one aspect of the present invention, a loudspeaker device comprises:

a flexible base member having a lower mounting plate portion, and an upper hanging portion connected to and disposed above the lower mounting plate portion, the lower mounting plate portion having opposite first and second side surfaces; and

a loudspeaker unit mounted on the first side surface of the lower mounting plate portion of the base member.

The upper hanging portion of the base member is bendable forcibly toward the second side surface of the lower mounting plate portion of the base member to form an inverted U-shaped structure.

According to another aspect of the present invention, a display assembly comprises:

a display unit having opposite front and rear surfaces;

a loudspeaker device including
a flexible base member having a lower mounting plate portion, and an upper hanging portion connected to and disposed above the lower mounting plate portion, the lower mounting plate portion having opposite first and second side surfaces, and
a loudspeaker unit mounted on the first side surface of the lower mounting plate portion of the base member,
wherein the upper hanging portion of the base member is bendable forcibly toward the second side surface of the lower mounting plate portion of the base member to form an inverted U-shaped structure, the inverted U-shaped structure being capable of being detachably hung on a top end of the display unit such that an assembly of the loudspeaker unit and the lower mounting plate portion of the base member is disposed in front of the front surface of the display unit; and

a positioning unit mounted on the rear surface of the display unit for positioning the inverted U-shaped structure on the display unit.

According to a further aspect of the present invention, a display assembly comprises:

a display unit having a front surface formed with a positioning member; and

a loudspeaker device including
a base member having a lower mounting plate portion, and an upper hanging portion connected to and disposed above the lower mounting plate portion, the lower mounting plate having opposite first and second side surfaces, the upper hanging portion being hung detachably on the positioning member such that the second side surface of the lower mounting plate portion faces the front surface of the display unit, and
a loudspeaker unit mounted on the first side surface of the lower mounting plate portion of the base member.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic front view of a conventional display assembly;

FIG. 2 is a partly exploded perspective view showing the first preferred embodiment of a display assembly according to the present invention;

FIG. 3 is a rear perspective view showing the first preferred embodiment;

FIG. 4 is a rear perspective view showing a loudspeaker device of the first preferred embodiment;

FIG. 5 is a schematic sectional view showing the first preferred embodiment;

FIGS. 6 and 7 are perspective views showing the loudspeaker devices of the first preferred embodiment when hung on a sofa and office partitions, respectively;

FIG. 8 is a schematic side view showing the loudspeaker device of the first preferred embodiment when hung on a chair;

FIG. 9 is a rear perspective view showing the second preferred embodiment of a display assembly according to the present invention;

FIG. 10 is a partly exploded perspective view showing the third preferred embodiment of a display assembly according to the present invention;

FIG. 11 is a perspective view showing the fourth preferred embodiment of a display assembly according to the present invention; and

FIG. 12 is a perspective view showing two loudspeaker devices of the fourth preferred embodiment when hung on a wall.

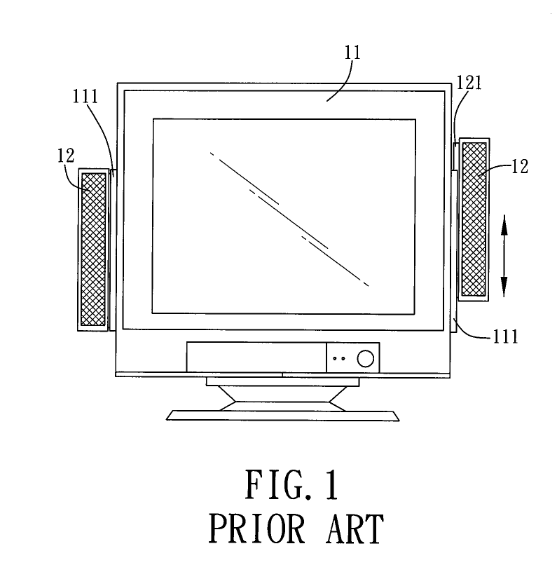

### DETAILED DESCRIPTION OF THE PREFERRED EMBODIMENTS

Before the present invention is described in greater detail, it should be noted that like elements are denoted by the same reference numerals throughout the disclosure.

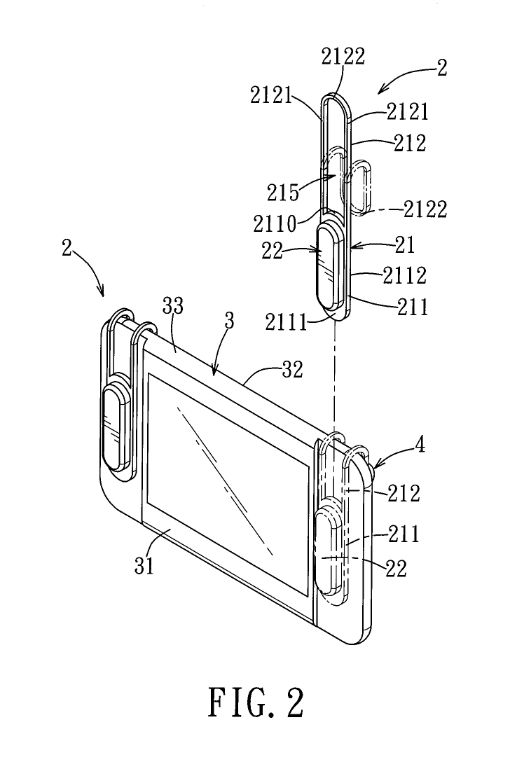

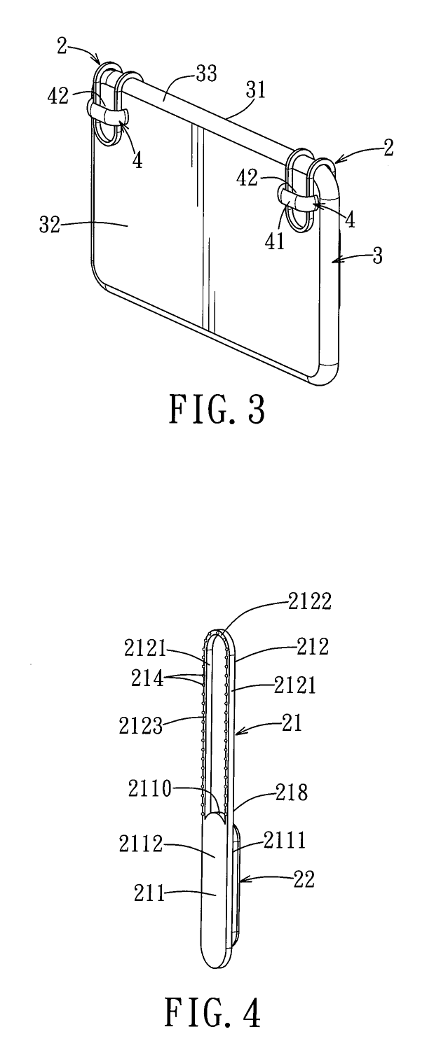

Referring to FIGS. 2 and 3, the first preferred embodiment of a display assembly according to the present invention is shown to include a display unit 3, a pair of loudspeaker devices 2, and a pair of positioning units 4.

The display unit 3 is a flat display, and has opposite front and rear surfaces 31, 32, and a top end 33.

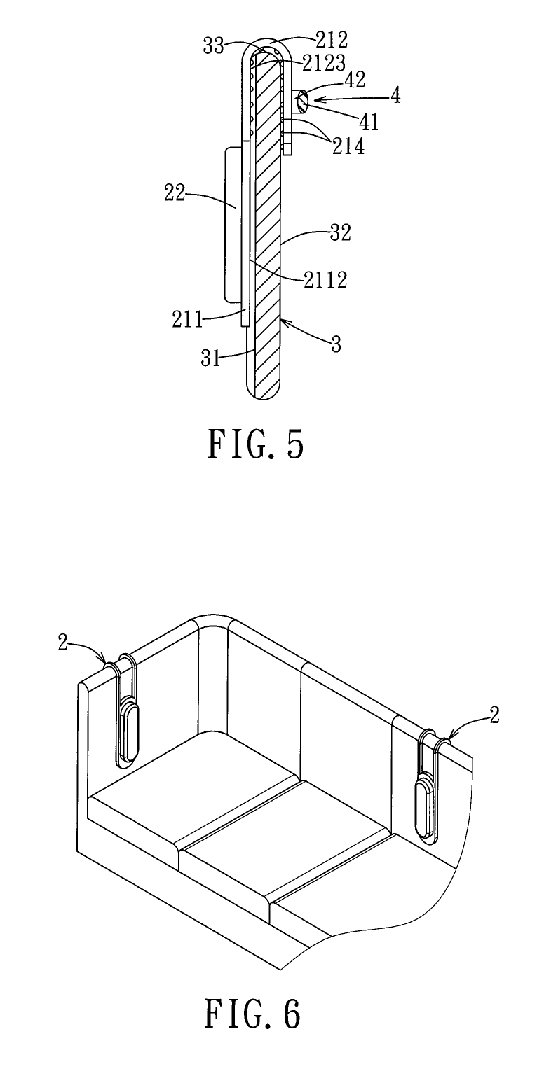

Referring further to FIGS. 4 and 5, each loudspeaker device 2 includes a flexible base member 21 and a loudspeaker unit 22. The base member 21 has a lower mounting plate portion 211, and an upper hanging portion 212 connected to and disposed above the lower mounting plate portion 211. The lower mounting plate portion 211 has opposite first and second side surfaces 2111, 2112. The loudspeaker unit 22 is mounted on the first side surface 2111 of the lower mounting plate portion 211 of the base member 21.

For each loudspeaker device 2, the upper hanging portion 212 of the base member 21 is bendable forcibly toward the second side surface 2112 of the lower mounting plate portion 211 of the base member 21 to form an inverted U-shaped structure. The inverted U-shaped structure is capable of being detachably hung on the top end 33 of the display unit 3 such that an assembly of the loudspeaker unit 22 and the lower mounting plate portion 211 of the base member 21 is disposed in front of the front surface 31 of the display unit 3, as shown in FIG. 2.

In this embodiment, for each loudspeaker device 2, the upper hanging portion 212 of the base member 21 is in the form of an inverted U-shaped rod that is made of copper and that has opposite lateral rod portions 2121 connected to a top end 2110 of the lower mounting plate portion 211, and an intermediate rod portion 2122 interconnecting the lateral rod portions 2121. The upper hanging portion 212 of the base member 21 has a side surface 2123 coplanar with the second side surface 2112 of the lower mounting plate portion 211 and formed with an anti-slip unit, which includes a plurality of anti-slip protrusions 214, to contact frictionally the display unit 3, as shown in FIG. 5.

Each positioning unit 4 is mounted on the rear surface 32 of the display unit 3 for positioning the inverted U-shaped structure, i.e., the bent upper hanging portion 212, of a corresponding one of the loudspeaker devices 2 on the display unit 3. In this embodiment, each positioning unit 4 includes a U-shaped rod 41 having opposite ends connected to the rear surface 32 of the display unit 3 and cooperating with the rear surface 32 of the display unit 3 to define a positioning hole 42 for permitting extension of the bent upper hanging portion 212 of the base member 21 of the corresponding one of the loudspeaker devices 2 therethrough, as shown in FIG. 3.

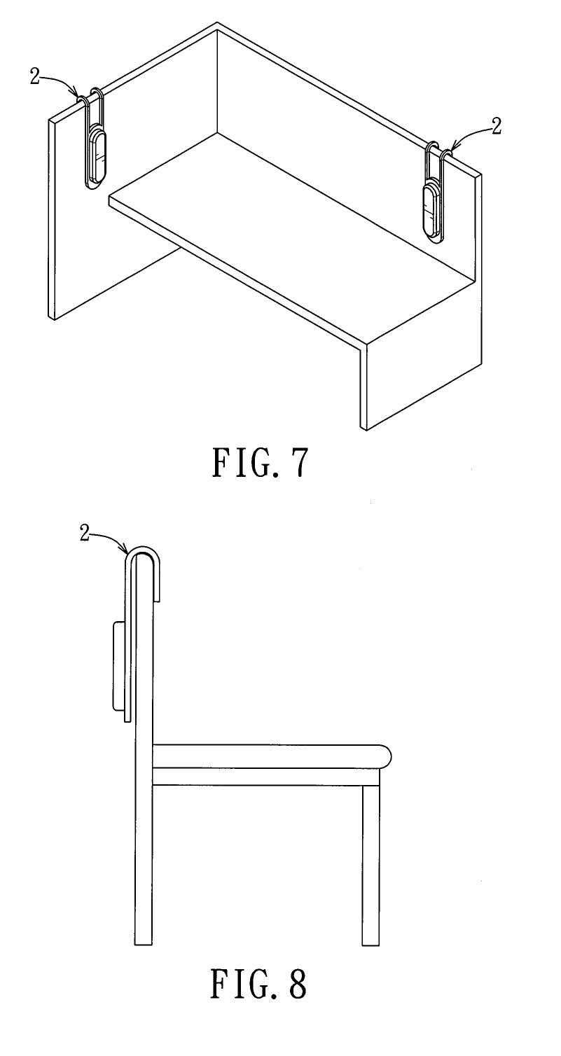

It is noted that, in use, the loudspeaker devices 2 can be separated from the display unit 3, and hung on a sofa, office partitions or a chair, as shown in FIGS. 6 to 8.

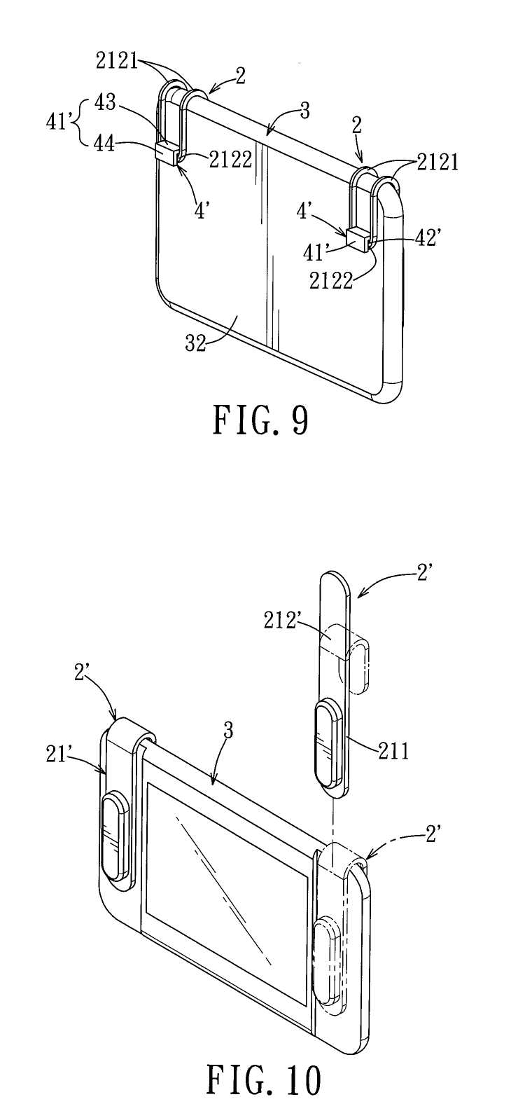

FIG. 9 illustrates the second preferred embodiment of a display assembly according to this invention, which is a modification of the first preferred embodiment.

In this embodiment, each positioning unit 4′ includes an inverted L-shaped plate 41′ that has a horizontal plate portion 43 extending rearwardly from the rear surface 32 of the display unit 3, and a vertical plate portion 44 connected fixedly to and extending downwardly from a rear end of the horizontal plate portion 43, and cooperating with the horizontal plate portion 43 and the rear surface 32 of the display unit 3 to define a positioning groove 42′ that engages detachably the intermediate rod portion 2122 of the inverted U-shaped rod (i.e., the bent upper hanging portion 212) of a corresponding one of the loudspeaker devices 2.

FIG. 10 illustrates the third preferred embodiment of a display assembly according to this invention, which is a modification of the first preferred embodiment. In this embodiment, for each loudspeaker device 2′, the upper hanging portion 212′ of the base member 21′ is in the form of an inverted U-shaped plate connected integrally to the lower mounting plate portion 211.

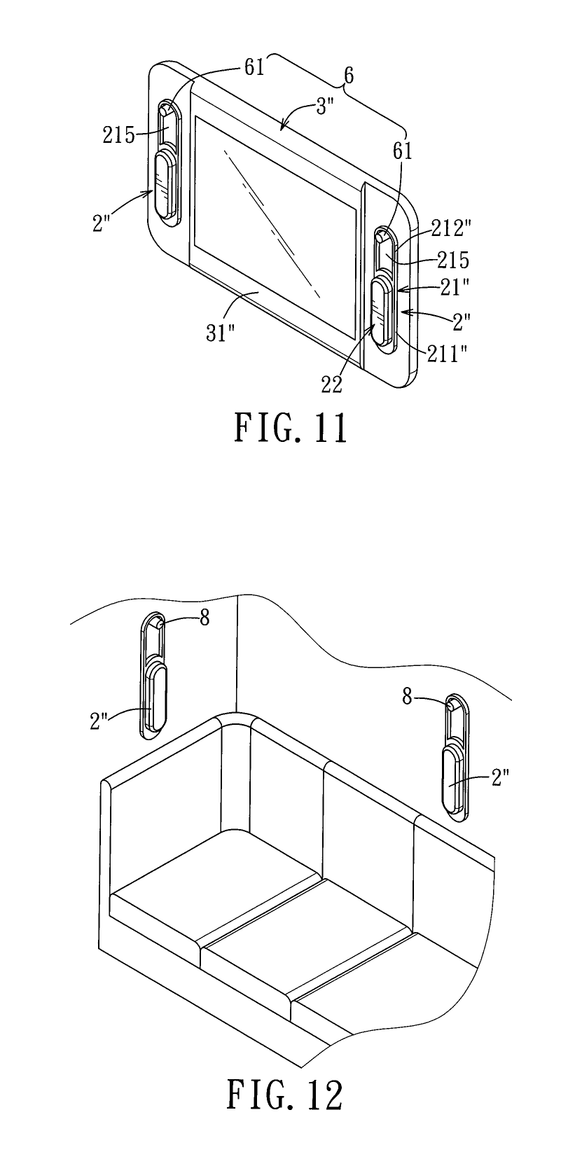

Referring to FIG. 11, the fourth preferred embodiment of a display assembly according to the present invention is shown to include a display unit 3″, and a pair of loudspeaker devices 2″.

The display unit 3″ has a front surface 31″ formed with a positioning member 6 that includes two positioning rods 61 in this embodiment. Each positioning rod 61 extends from the front surface 31″ of the display unit 3″.

Each loudspeaker device 2″ includes a base member 21″ and a loudspeaker unit 22, wherein the base member 21″ has a lower mounting plate portion 211″ mounted with the loudspeaker unit 22 on a first side surface thereof, and a flexible upper hanging portion 212″ connected to and disposed above the lower mounting plate portion 211″, and formed with a through hole 215 that permits extension of a corresponding one of the positioning rods 61 of the positioning member 6 therethrough so as to position the loudspeaker device 2″ on the front surface 31″ of the display unit 3″. In other words, for each loudspeaker device 2″, the upper hanging portion 212″ is hung detachably on the corresponding one of the positioning rods 61 of the positioning member 6 such that a second side surface of the lower mounting plate portion 211″ is opposite to the first side surface and confronts the front surface 31″ of the display unit 3″.

It is noted that, in use, the loudspeaker devices 2″ can be separated from the display unit 3″, and hung on a hanger 8 on a wall surface, as shown in FIG. 12.

In sum, since the upper hanging portions 212, 212′ of the base member 21, 21′ of the loudspeaker devices 2, 2′ of the first to third preferred embodiments are designed to be flexible, the loudspeaker devices 2, 2′ can be easily hung on the display unit 3 using the inverted U-shaped structure obtained by bending the upper hanging portions 212, 212′. Alternatively, in the fourth preferred embodiment, due to the presence of the through hole 215 in each loudspeaker device 2″, the loudspeaker devices 2″ can be easily hung on the display unit 3″. Moreover, in use, the loudspeaker devices 2, 2′, 2″ can be separated from the display unit 3, 3″, and can be easily positioned on other objects, such as a sofa, a chair, office partitions or a wall surface.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A loudspeaker device comprising:
a flexible base member having a lower mounting plate portion, and an upper hanging portion connected to and disposed above said lower mounting plate portion, said lower mounting plate portion having opposite first and second side surfaces; and
a loudspeaker unit mounted on said first side surface of said lower mounting plate portion of said base member;
wherein said upper hanging portion of said base member is bendable forcibly toward said second side surface of said lower mounting plate portion of said base member to form an inverted U-shaped structure.

2. The loudspeaker device as claimed in claim 1, wherein said upper hanging portion of said base member is formed with a through hole.

3. The loudspeaker device as claimed in claim 2, wherein said upper hanging portion of said base member is in the form of an inverted U-shaped rod that cooperates with said lower mounting plate portion so as to define said through hole.

4. The loudspeaker device as claimed in claim 1, wherein said upper hanging portion of said base member has a side surface coplanar with said second side surface of said lower mounting plate portion and formed with an anti-slip unit.

5. The loudspeaker device as claimed in claim 4, wherein said anti-slip unit includes a plurality of anti-slip protrusions.

6. A display assembly comprising:
a display unit having opposite front and rear surfaces;
a loudspeaker device including
a flexible base member having a lower mounting plate portion, and an upper hanging portion connected to and disposed above said lower mounting plate portion, said lower mounting plate portion having opposite first and second side surfaces, and
a loudspeaker unit mounted on said first side surface of said lower mounting plate portion of said base member,
wherein said upper hanging portion of said base member is bendable forcibly toward said second side surface of said lower mounting plate portion of said base member to form an inverted U-shaped structure, said inverted U-shaped structure being capable of being detachably hung on a top end of said display unit such that an assembly of said loudspeaker unit and said lower mounting plate portion of said base member is disposed in front of said front surface of said display unit; and
a positioning unit mounted on said rear surface of said display unit for positioning said inverted U-shaped structure on said display unit.

7. The display assembly as claimed in claim 6, wherein said positioning unit includes a U-shaped rod having opposite ends connected to said rear surface of said display unit and cooperating with said rear surface of said display unit to define a positioning hole for permitting extension of said upper hanging portion of said base member therethrough when said upper hanging portion is bent into said inverted U-shaped structure.

8. The display assembly as claimed in claim 6, wherein:
said upper hanging portion of said base member is in the form of an inverted U-shaped rod that has opposite lateral rod portions connected to a top end of said lower mounting plate portion, and an intermediate rod portion interconnecting said lateral rod portions; and
said positioning unit includes an inverted L-shaped plate that has a horizontal plate portion extending rearwardly from said rear surface of said display unit, and a vertical plate portion connected fixedly to and extending downwardly from a rear end of said horizontal plate portion, and cooperating with said horizontal plate portion and said rear surface of said display unit to define a positioning groove that engages detachably said intermediate rod portion of said inverted U-shaped rod.

9. The display assembly as claimed in claim 6, wherein said upper hanging portion of said base member has a side surface coplanar with said second side surface of said lower mounting plate portion and formed with an anti-slip unit to contact frictionally said display unit.

10. The display assembly as claimed in claim 9, wherein said anti-slip unit includes a plurality of anti-slip protrusions.

11. A display assembly comprising:
a display unit having a front surface formed with a positioning member; and
a loudspeaker device including
a base member having a lower mounting plate portion, and an upper hanging portion connected to and disposed above said lower mounting plate portion, said lower mounting plate having opposite first and second side surfaces, said upper hanging portion being hung detachably on said positioning member such that said second side surface of said lower mounting plate portion face said front surface of said display unit, and
a loudspeaker unit mounted on said first side surface of said lower mounting plate portion of said base member.

12. The display assembly as claimed in claim 11, wherein:
said upper hanging portion of said base member is formed with a through hole; and
said positioning member includes a positioning rod that extends from said front surface of said display unit through said through hole in said upper hanging portion of said base member so as to position said loudspeaker device on said front surface of said display unit.

13. The display assembly as claimed in claim 11, wherein said upper hanging portion of said base member is made of a flexible material.

14. The display assembly as claimed in claim 13, wherein said upper hanging portion of said base member is bendable forcibly toward said second side surface of said lower mounting plate portion of said base member to form an inverted U-shaped structure.
